(19) United States
(12) Patent Application Publication
(10) Pub. No.: US 2014/0184699 A1
(43) Pub. Date: Jul. 3, 2014

(54) FILM MEMBER AND LIQUID EJECTING APPARATUS

(71) Applicant: Seiko Epson Corporation, Tokyo (JP)

(72) Inventors: Koji ITO, Shiojiri-shi (JP); Shigenori NAKAGAWA, Nagano-ken (JP); Yuji KANAZAWA, Shiojiri-shi (JP)

(73) Assignee: SEIKO EPSON CORPORATION, Tokyo (JP)

(21) Appl. No.: 14/132,483

(22) Filed: Dec. 18, 2013

(30) Foreign Application Priority Data
Dec. 27, 2012 (JP) 2012-286264

(51) Int. Cl. B41J 2/14

(52) U.S. Cl. CPC B41J 2/14
USPC 347/54

(57) ABSTRACT

A film member includes an inside film layer which is disposed on a surface in contact with liquid; an outside film layer which is disposed on the opposite side to the surface of the inside film layer in contact with the liquid; and a junction layer which is disposed between the inside film layer and the outside film layer to join the inside film layer and the outside film layer, in which an SP value (here, the SP value represents a solubility parameter value) of a resin material which forms the junction layer is equal to or larger than an SP value of a resin material that forms the inside film layer, and an SP value of a resin material that forms the outside film layer is equal to or larger than the SP value of the resin material that forms the inside film layer.

### BACKGROUND

1. Technical Field

The present invention relates to a film member which is used in a portion that is in contact with liquid such as ink in a liquid ejecting apparatus, and a liquid ejecting apparatus which includes the film member.

2. Related Art

In the related art, as one type of a liquid ejecting apparatus, there has been known an ink jet type printer which prints (records) an image on a medium such as paper by ejecting ink, as an example of liquid, from a liquid ejecting head (for example, JP-A-2011-46070 (for example, paragraph [0035] and FIG. 7)). In such a printer, a film member has been used in a portion, which is in contact with the ink, of an ink flow passage from an ink supply source to the liquid ejecting head in some cases.

For example, a printer disclosed in JP-A-2011-46070 (for example, paragraph [0035] and FIG. 7) is provided with a pressure regulating valve which has the film member used in a portion that is in contact with ink. The pressure regulating valve has a concave portion which is formed in a valve housing and a pressure regulating chamber which is formed of a film member welded to the valve housing so as to cover the opening of the concave portion. The film functions as a diaphragm and when the ink in a liquid ejecting head is consumed and an amount of the ink in the pressure regulating chamber is reduced, the film member is recessed to the chamber due to differential pressure between the atmospheric pressure outside the film and the ink pressure in the chamber and a rod of a valve body is pressed against a biasing force of a spring. Accordingly, the pressure regulating valve is opened and the pressure regulating chamber is replenished with ink from the upstream side (ink supply source side). Then, a predetermined amount of ink is supplied to the pressure regulating chamber and the film member is displaced to the atmosphere so that the valve body is returned by the biasing force of the spring. Then, the pressure regulating valve is closed and the ink supply to the pressure regulating chamber is stopped.

The film member having a laminated structure which is provided in the pressure regulating valve disclosed in JP-A-2011-46070 (for example, paragraph [0035] and FIG. 7) includes a thin film-like polypropylene (PP) film (inside film layer) which is disposed on a surface which is in contact with ink and regulates permeation of ink, and a thin film-like moisture-proof film which is disposed on the outside opposing to the inside in contact with ink in the PP film and regulates permeation of moisture. Further, at least one layer of thin film-like polyethylene terephthalate (PET) film (outside film layer) is disposed between the PP film and the moisture-proof film to bond the PP film and the PET film by an adhesion layer (junction layer) which is formed of an adhesive.

In the film member of the related art in which a moisture-proof film is not provided, when a solvent ink which contains a glycol ether-based solvent as a main component of the solvent is used (for example, JP-A-2007-246866 (for example, paragraphs [0014], [0015], [0029] to [0055] and the like)), ink which is attracted to moisture passing through an outer film which is in contact with the atmosphere and infiltrating between the outer film and an inner film infiltrates between the outer film and the inner film to cause swelling of the film member. However, according to the film member disclosed in JP-A-2011-46070 (for example, paragraph [0035] and FIG. 7), even when a solvent ink is used, moisture in the atmosphere passing through the outer film which is in contact with the atmosphere is prevented from infiltrating between the outer film and the inner film by the moisture-proof film and thus, swelling of the film member can be prevented.

However, in the film member disclosed in JP-A-2011-46070 (for example, paragraph [0035] and FIG. 7), swelling of the film member due to the infiltration of the ink, which is attracted to the moisture passing through the outer film which is in contact with the atmosphere and infiltrating between the inner film and the outer film, between the inner film and the outer film is noticed. However, there are various causes of the occurrence of swelling of the film member, and while a solvent in ink penetrates the film member, accumulation of the solvent at an interface causes swelling (interfacial peeling) in some cases depending on the combination of materials of each layer forming the film member, in addition to the infiltration of the moisture in the atmosphere into the film member. It is necessary to prevent this type of swelling.

Such a problem is not limited to the pressure regulating valve disclosed in JP-A-2011-46070 (for example, paragraph [0035] and FIG. 7) and also exists in other valves, flow passages, dampers, liquid packs (for example, ink packs) in liquid ejecting apparatuses in which a film member is used in a portion which is in contact with liquid in the same manner.

### SUMMARY

An advantage of some aspects of the invention is to provide a film member capable of efficiently preventing swelling of the film member caused by accumulation of a solvent in liquid penetrating from a surface of the film member formed of a laminated body, which is in contact with the liquid, at an interface between layers, and a liquid ejecting apparatus.

According to an aspect of the invention, there is provided a film member which is used in a portion in contact with liquid in a liquid ejecting apparatus, including: an inside film layer which is disposed on a surface in contact with the liquid; an outside film layer which is disposed on the opposite side to the surface of the inside film layer in contact with the liquid; and a junction layer which is disposed between the inside film layer and the outside film layer to join the inside film layer and the outside film layer, in which an SP value (here, the SP value represents a solubility parameter value) of a resin material which forms the junction layer is equal to or larger than an SP value of a resin material that forms the inside film layer, and an SP value of a resin material that forms the outside film layer is equal to or larger than the SP value of the resin material that forms the inside film layer.

In the configuration, the solvent in the liquid penetrates the inside film layer and then, sequentially penetrates the junction layer and the outside film layer. During the penetration process, due to the relationship among the SP values of the resin materials which respectively form the inside film layer, the junction layer and the outer film layer, the solvent is not accumulated at the interface between the inside film layer and the junction layer, and at the interface between the junction layer and the outside film layer with a degree of causing swelling, and evenly penetrates the respective layers at a remarkable penetration rate. Therefore, it is possible to prevent swelling caused by accumulation of the solvent at the interface between the layers of the film member.

In the film member, it is preferable that the resin material of the inside film layer be polypropylene or polyethylene.

In the configuration, even when polypropylene or polyethylene is used as the resin material of the inside film layer, swelling of the film member can be efficiently prevented from occurring.

In the film member, it is preferable that the resin material of the outside film layer be polyester or polyamide.

In the configuration, even when polyester or polyamide is used as the outside film layer, swelling of the film member can be efficiently prevented from occurring.

In the film member, it is preferable that a difference between the SP value of the resin material that forms the junction layer and the SP value of the resin material that forms the outside film layer be smaller than a difference between the SP value of the resin material that forms the junction layer and the SP value of the resin material that forms the inside film layer.

In the configuration, in a process where the solvent in the liquid penetrates the film member from the surface on the side of the inside film layer, the solvent more easily penetrates between the junction layer and the outside film layer than between the inside film layer and the junction layer due to the relationship of the differences of the SP values. In addition, adhesive force between the resin materials of the junction layer and the outside film layer having a smaller difference between the SP values is stronger than between the resin materials of the inside film layer and the junction layer. Accordingly, in the middle of penetrating the film member, the solvent is not easily accumulated at the interface between the layers and further, even if the solvent is accumulated at the interface between the junction layer and the outside film layer, peeling does not easily occur at the interface in which the layers are bonded by a strong interlayer adhesive force and thus, swelling of the film member can be more efficiently prevented from occurring.

According to another aspect of the invention, there is provided a liquid ejecting apparatus including the film member in the portion which is in contact with the liquid.

In the configuration, even when the film member is used in the portion which is in contact with the liquid in the liquid ejecting apparatus, swelling caused by penetration of at least a solvent in the liquid into the film member can be prevented from occurring.

In the liquid ejecting apparatus, it is preferable that an SP value of a water soluble organic solvent which is most largely contained among water soluble organic solvents contained in the liquid be equal to or larger than 16.5 and smaller than 24.6.

In the configuration, even when the liquid in which the water soluble organic solvent having an SP value of equal to or larger than 16.5 and smaller than 24.6 is most largely contained among the water soluble organic solvents is used, swelling of the film member can be prevented from occurring.

Further, in the liquid ejecting apparatus, it is preferable that the water soluble organic solvent which is most largely contained in the liquid be diethyleneglycol diethyl ether, and a content thereof be equal to or more than 30% by mass with respect to the total mass of ink.

In the configuration, even when the liquid having a content of diethyleneglycol diethyl ether, which is most largely contained as a water soluble organic solvent to be included in the liquid, of equal to or more than 30% by mass with respect to the total mass of ink is used, swelling of the film member can be prevented from occurring.

### BRIEF DESCRIPTION OF THE DRAWINGS

The invention will be described with reference to the accompanying drawings, wherein like numbers reference like elements.

FIG. 1 is a plan view of a printer according to an embodiment.

FIGS. 2A and 2B are side cross-sectional views of a valve unit.

FIG. 3 is a schematic cross-sectional view of a film member.

### DESCRIPTION OF EXEMPLARY EMBODIMENTS

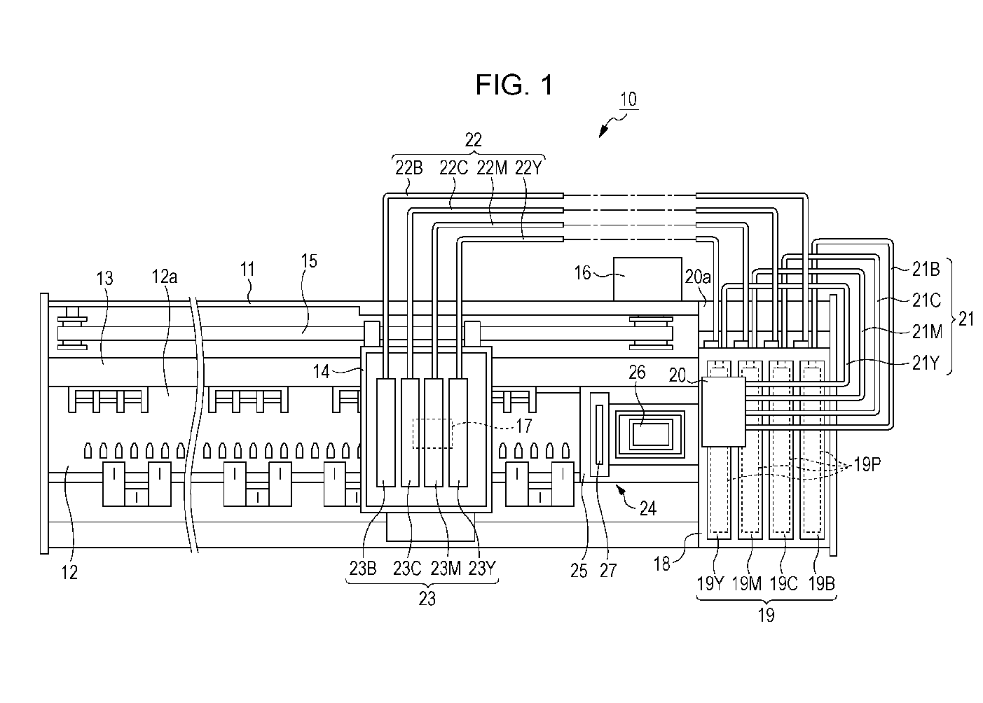

Hereinafter, a film member and an ink jet type printer as an example of a liquid ejecting apparatus in which the film member is provided in a portion in contact with liquid will be described with reference to FIGS. 1 to 3. First, a schematic configuration of the ink jet type printer will be described with reference to FIG. 1.

As shown in FIG. 1, an ink jet type printer 10 includes a substantially rectangular parallelepiped box-like frame 11 which is provided in a housing (not shown) and is provided with the upper side (near side of a paper plane in FIG. 1) opened, and a paper feeding apparatus 12 which is installed on the bottom side in the frame 11. Printing paper (medium), (not shown) is fed onto a supporting plate 12a forming the paper feeding apparatus 12 by a paper feeding mechanism. In addition, a guiding member 13 is installed in the frame 11 in a state in which the guiding member is arranged parallel to a longitudinal direction (horizontal direction in FIG. 1) of the supporting plate 12a of the paper feeding apparatus 12. A carriage 14 is supported by the guiding member 13 so as to be movable in an axial direction of the guiding member 13. The carriage 14 is connected to a carriage motor 16 through a timing belt 15 in a state in which power can be transmitted. Since the carriage motor 16 is driven to rotate forward and reverse, the carriage 14 reciprocates along the guiding member 13 in a main scanning direction. On a surface (bottom surface) of the carriage 14 opposed to the supporting plate 12a, a recording head 17 as an example of a liquid ejecting head is mounted.

A cartridge holder 18 is provided at an end (right end in FIG. 1) of the frame 11. Plural ink cartridges 19, which store ink as an example of liquid, as an example of a liquid supply source, are detachably attached to the cartridge holder 18. In the embodiment, four colors of ink of black (K), cyan (c), magenta (M) and yellow (Y) are used. In the printer 10 according to the embodiment, four cartridges 19B, 19C, 19M and 19Y corresponding to these four kinds of ink are mounted. An ink pack 19P in which the black ink is stored in the cartridge 19B, the cyan ink is stored in the ink cartridge 19C, the magenta ink is stored in the ink cartridge 19M, and the yellow ink is stored in the ink cartridge 19Y is accommodated.

A pressurizing pump 20 is disposed in an upper position from the attached position of the ink cartridges 19 in the cartridge holder 18. The other ends of four air supply tubes 21 extending from the pressurizing pump 20 are connected to the four ink cartridges 19. Further, ends of four ink supply tubes 22 are respectively connected to the four ink cartridges 19. When the pressurizing pump 20 is driven, air to be pressurized is supplied to the ink cartridges 19 through the air supply tubes 21, the ink in the ink pack 19P in the ink cartridge 19 is pressurized by the air, and the pressurized ink in the ink pack 19P is supplied to the ink supply tubes 22. In the embodiment, the four air supply tubes 21 are respectively set to the air supply tubes 21B, 21C, 21M and 21Y, and the four ink supply tubes 22 are respectively set to the ink supply tubes 22B, 22C, 22M and 22Y to correspond to four colors of ink. In addition, in the embodiment, a flow passage valve 20a which regulates an amount of ink flowing in the ink supply tube 22 is provided in the middle of the ink supply tube 22.

Four valve units 23 are mounted on the carriage 14. The valve units 23 in the example are pressure regulating valves. In the embodiment, the four valve units 23 are respectively set to the valve units 23B, 23C, 23M and 23Y to correspond to four colors of ink. To each of the valve units 23B, 23C, 23M and 23Y, the other ends of the ink supply tubes 22B, 22C, 22M and 22Y are respectively connected. As described above, the ink supplied to each of the ink supply tubes 22B, 22C, 22M and 22Y is supplied to the recording head 17 through each of the valve units 23B, 23C, 23M and 23Y. That is, in the embodiment, the ink supply tubes 22 and the valve units 23 form a part of a liquid flow passage for supplying ink to the recording head 17 from the ink cartridges 19. On the bottom surface of the recording head 17 (nozzle forming surface), nozzles (not shown), which communicate with the outlet of each of the valve units 23B, 23C, 23M and 23Y and respectively have a predetermined number (as an example, 180) for each color of ink, are opened. The printer 10 performs color or black printing by ejecting ink droplets onto a surface of printing paper from the nozzles of the recording head 17.

In a non-print region 24 (home position) set at the other end (the right end in FIG. 1) of the moving path of the carriage 14 in which the carriage 14 stands by when printing is not performed, a capping device 25 is disposed. The capping device 25 includes a capping member 26 which performs capping by allowing the recording head 17 to be in contact with the nozzle forming surface, and a wiper 27 which can wipe out the nozzle forming surface of the recording head 17. When the carriage 14 moves to the non-print region 24, the capping device 25 allows the capping member 26 to cap the recording head 17 and therefore, an increase in viscosity and drying of the ink in the nozzles of the recording head 17 is prevented. In addition, when a predetermined wiping time nears, the capping device 25 moves the wiper 27 up to a predetermined wiping position and in the up state, and the wiper 27 wipes out the nozzle forming surface of the recording head 17, for example, by moving the carriage 14 from the non-print region 24 to a print region.

Next, the configuration of the valve unit 23 will be described in detail.

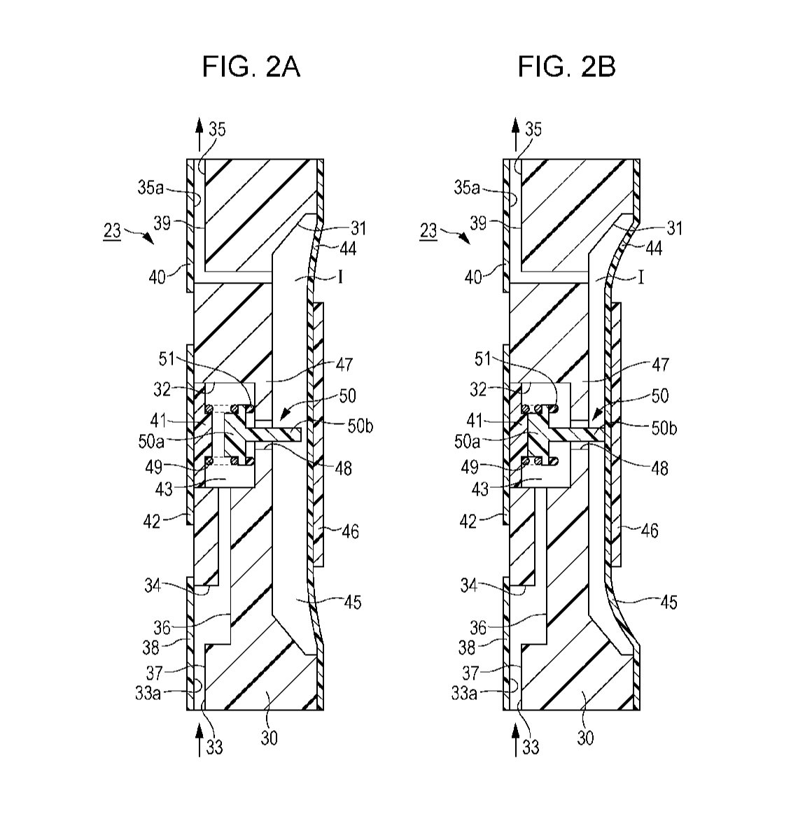

As shown in FIGS. 2A and 2B, the valve unit 23 is provided with a substrate 30 formed of a synthetic resin. A concave portion 31 is formed on one side of the substrate 30 (right side in FIGS. 2A and 2B) and a concave portion 32 is formed on the other side of the substrate 30 (left side in FIGS. 2A and 2B). On the side surface of the concave portion 32, one end of an introduction passage 33 which extends along a predetermined path passing through the substrate 30 is opened. In the middle of the introduction passage 33, a damper 34 is formed, and further, a flow passage section 33a which forms an upstream portion of the damper 34 in the introduction passage 33 is opened to one end (lower end in FIGS. 2A and 2B) of the substrate 30. The introduction passage 33 communicates with the ink supply tube 22 through the opening.

On the other hand, a discharge passage 35 which extends along a predetermined path passing through the substrate 30 is opened on the bottom surface of the concave portion 31. The discharge passage 35 is opened to the other end (upper end in FIGS. 2A and 2B) of the substrate 30 and communicates with the recording head 17 through the opening.

Here, a film member 38 is thermally welded to the substrate 30 in the formation region of the damper 34 and the flow passage section 33a on the other side (left side in FIGS. 2A and 2B) of the substrate 30 in a state in which the film member covers both openings of a concave portion 36 and a groove 37 which are recessed in the formation region. The damper 34 is formed by the concave portion 36 and the portion which covers the concave portion 36 of the film member 38 and the flow passage section 33a is formed by the groove 37 and the portion which covers the groove 37 of the film member 38 as a flow passage. The damper 34 is a liquid chamber having a cross-sectional area larger than the cross-sectional area of the flow passage on the upstream side or downstream side of the damper and the pressure fluctuation of the ink that is supplied to the introduction passage 33 is damped by the damper 34.

In addition, a groove 39 is formed in a predetermined region corresponding to the discharge passage 35 on the other side of the substrate 30 and a film member 40 is thermally welded in a state in which the film member covers the opening of the groove 39. A flow passage section 35a which extends along the other side of the substrate 30 in the discharge passage 35 is formed by the groove 39 and the film member 40.

A spring receiving seat 41 is fitted to the concave portion 32 shown in FIGS. 2A and 2B so as to block the opening of the concave portion. In addition, a film member 42 is fixed on the other side of the substrate 30 so as to cover the concave portion 32 from the top of the spring receiving seat 41. Since the concave portion is sealed by the film member 42, an ink supply chamber 43 is formed in a state in which the leakage of ink from a gap of the fitted portion of the concave portion 32 and the spring receiving seat 41 is prevented.

On one side (right side in FIG. 2) of the substrate 30, a flexible film member 44 covers the opening of the concave portion 31 and is fixed without being loosened to the side of the concave portion 31. Therefore, a pressure chamber 45 which is surrounded by the inner surface of the concave portion 31 and the film member 44 in a sealed state is formed. A pressure receiving plate 46 having a width narrower than the width of the concave portion 31 is fixed to the center portion of the surface of the film member 44 opposite to the surface on the side of the concave portion 31.

A partition wall 47 which partitions both chambers 45 and 43 is provided between the pressure chamber 45 and the ink supply chamber 43. In the partition wall 47, a through hole 48 is formed while passing through the pressure chamber 45 and the ink supply chamber 43. In the ink supply chamber 43, a valve body 50 which includes a substantially disk-shaped base 50a supported by the spring receiving seat 41 through a coil spring 49, and a bar-like rod 50b extending from the center portion of the base 50a and passing through the through hole 48 is arranged. In a state in which the valve unit 23 shown in FIG. 2A is closed, a tip end of the rod 50b of the valve body 50 is slightly separated from the inner surface of the film member 44 in the pressure chamber 45.

An annular sealing member 51 is provided in the base 50a of the valve body 50 so as to surround the rod 50b. The inside diameter of the sealing member 51 is set to be larger than the diameter of the through hole 48. Usually, the valve unit 23 is in a closed state shown in FIG. 2A in which the base 50a of the valve body 50 is closely attached to the partition wall 47 through the sealing member 51 by the biasing force of the coil spring 49 and the through hole 48 is blocked by the valve body 50.

As ink is consumed in the recording head 17, the ink in the pressure chamber 45 is supplied (discharged) to the recording head 17 through the discharge passage 35. As the amount of ink in the pressure chamber 45 is decreased, negative pressure is generated in the pressure chamber 45, and therefore, particularly, a portion of the film member 44 to which the pressure receiving plate 46 is fixed is recessed so as to keep balance between the negative pressure and the atmospheric pressure outside. Further, when the amount of ink in the pressure chamber 45 is decreased and the pressing force of the film member 44 due to the atmospheric pressure is larger than the biasing force of the coil spring 49, the rod 50b (valve body 50) is pressed by the pressure receiving plate 46 through the film member 44 to the side of the spring receiving seat 41 against the biasing force. Due to the pressing, the valve unit 23 is in an open state shown in FIG. 2B in which the sealing member 51 is separated from the partition wall 47.

In the open state, the ink in the ink supply chamber 43 flows into the pressure chamber 45 through the through hole 48, the valve body 50 moves to the pressure chamber 45 by the biasing force of the coil spring 49, and the valve unit 23 is in the closed state shown in FIG. 2A in which the through hole 48 is blocked by the valve body 50 again. Thus, the valve unit 23 has the pressure chamber 45 in which a constant pressure is maintained regardless of an increase or a decrease in the amount of ink in the pressure chamber 45. Here, the valve unit 23 is a so-called self-sealing valve and has a function of regulating pressure of ink to be supplied to the recording head 17 (self-sealing function). In the embodiment, a bag portion of the ink pack 19P having flexibility is formed using the same film member as the film member 44.

The film members 38, 40, 42 and 44 provided in portions in contact with an ink I in the printer 10 in the example has a film laminated structure in which plural films formed of a combination of specific synthetic resin materials are laminated. At least one of the film members 38, 40, 42 and 44 may be a film having the specific film laminated structure. In the embodiment, since the film member 38, 40, 42 and 44 have the same specific film laminated structure, the film laminated structure will be described below using the film member 44 as an example.

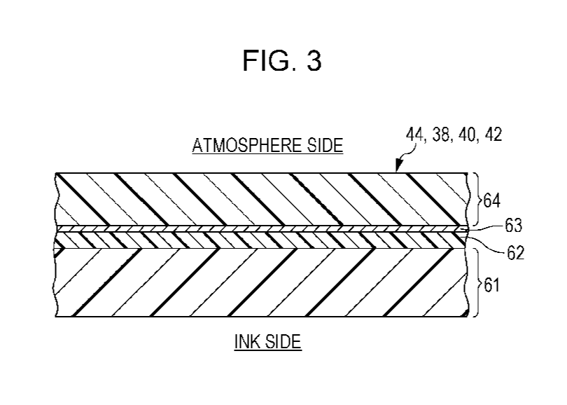

FIG. 3 is a schematic cross-sectional view of the film member 44 which is cut in a direction perpendicular to a laminated surface. As shown in the drawing, the film member 44 (38, 40, 42) includes an inside film layer 61, a junction layer 62, a gas barrier layer 63, and an outside film layer 64 sequentially laminated in this order from an inner surface side which is in contact with an ink I as an example of liquid.

In the embodiment, a sealing portion in which the film member 44 (38, 40, 42) is pressed and thermally welded to the substrate 30 formed of the same material as the inside film layer 61 by a heating tool using the inside film layer 61 as a welding surface, and therefore, the flow passage sections 33a and 35a, the damper 34, the ink supply chamber 43, and the pressure chamber 45 shown in FIGS. 2A and 2B are formed. In addition, the ink pack 19P is manufactured by pressing and thermally welding a portion in which end edges of a surface (welding surface) of the film member 44 bent in a cylindrical shape (bag shape) on the side of the inside film layer 61 are matched by the heating tool to form a sealing portion.

The inside film layer 61 has a thickness in a range of, for example, 10 μm to 50 μm, and the outside film layer 64 has a thickness in a range of, for example, 5 μm to 30 μm.

In addition, the junction layer 62 has a thickness in a range of, for example, 1 μm to 10 μm. The thickness is not limited to the above values and the thickness of each of the film layers 61 and 64 and the thickness of the junction layer 62 can be appropriately changed depending on applications of the film member 44, required functions and strength, and further, joining methods to be used.

The gas barrier layer 63 is formed of a deposited layer of an inorganic material or a metal material deposited on a surface of the outside film layer 64 opposite to the inside film layer 61. For example, the thickness of the gas barrier layer 63 has a value in a range of 10 Å to 2 μm. Particularly, the thickness of the gas barrier layer 63 in the example has a value in a range of 20 Å to 1 μm. In this manner, the thickness of the gas barrier layer 63 is extremely thin in comparison with the thickness of the film layers 61 and 64 and the junction layer 62. In addition, when the gas barrier layer 63 is a deposited layer, the gas barrier layer is deposited on a surface of the outside film layer 64 opposite to the junction layer 62 in advance. However, the deposited layer is microscopically uneven in comparison with a metal foil and the like and has a microscopic gap. Therefore, in a state in which the inside film layer 61 and the outside film layer 64 are joined to each other by the junction layer 62, a resin material forming the junction layer which penetrates the microscopic gap of the gas barrier layer 63 is joined to a resin material of the substrate positioned on the opposite side of the junction layer through the deposited layer of the outside film layer 64.

In the embodiment, each resin material forming the inside film layer 61 and the outside film layer 64 are selected so as to satisfy the following condition using a solubility parameter (SP value). That is, a combination of resin material which satisfy the condition in which an SP value of the resin material forming the outside film layer 64 is larger than an SP value of the resin material forming the inside film layer 61 is selected. Here, the SP value, which is a value of a solubility parameter, is a value expressed by a square root of molecular aggregation energy, and can be calculated by the method described by R. F. Fedors, in “Polymer Engineering Science”, 14, p 147 (1974). The unit is (MJ/m³)^{1/2}, and the SP value indicates a value at 25° C.

In the example, polypropylene (PP) or polyethylene (PE) (SP value=16.4) is used as an example of the resin material of the inside film layer 61 in resin materials satisfying the above condition and having good solvent resistance. In addition, from the viewpoint of gas barrier properties and prevention of fixation between the heating tool and the film member during thermal welding, polyester or polyamide (PA) is used as an example of the resin material of the outside film layer 64. Preferred examples of the polyester include poly-ethylene-terephthalate (PET) (SP value=21.8).

Further, the junction layer 62 is a junction layer which is formed in a joined portion by joining the inside film layer 61 and the outside film layer 64, and the material and the thickness thereof depend on joining methods. Examples of the joining methods include a bonding method using an adhesive, a lamination method and a welding method. Examples of the laminating method include an extrusion lamination, a dry lamination method, a wet lamination method, a thermal lamination method, a hot melt lamination method, and an inflation method. Further, examples of the welding method include a thermal welding method and a vibration welding method.

The extrusion lamination method is a method in which a thermoplastic resin (sealant material) is melt to be extruded in a film shape using a die and the extruded resin is laminated (bonded) to the substrate. In this case, in order to increase the adhesive strength of the substrate and the melted resin, an anchor coating agent may be applied on the bonding surface of the substrate. In the example, when PET is used as the resin material of the outside film layer 64 in the extrusion lamination method, the PET is used as the substrate. The resin film of the inside film layer 61 may be used as the substrate to perform extrusion lamination.

In the embodiment, a resin material having an SP value of equal to or larger than the SP value of the resin material of the inside film layer 61 is used as the resin material of the junction layer 62. For example, when the bonding method is used, a urethane resin-based adhesive, a special urethane resin-based adhesive and the like are used as an adhesive. In this case, a urethane resin, a special urethane resin and the like are used as an example of the resin material of the junction layer 62. In the extrusion lamination method, when an anchor coating agent is applied on the substrate, an anchor layer that is formed between the inside film layer 61 and the outside film layer 64 is the junction layer 62.

In the film member 44 of the embodiment, a difference between the SP value of the resin material forming the junction layer 62 and the SP value of the resin material forming the outside film layer 64 is smaller than a difference between the SP value of the resin material forming the junction layer 62 and the SP value of the resin material forming the inside film layer 61.

In the printer 10 according to the embodiment, solvent ink is used as the ink I. The solvent ink includes water soluble organic solvents as a pigment dispersion medium. Then, a water soluble organic solvent, which is most largely contained among the water soluble organic solvents in the solvent ink, satisfies a condition in which the SP value of the water soluble organic solvent is equal to or larger than 16.5 and smaller than 24.6, and has a content of equal to or more than 30% by mass with respect to the total mass of ink. In the example, the water soluble organic solvent which is most largely contained in the ink is diethyleneglycol diethyl ether and the SP value thereof is 16.8 (MJ/m³)^{1/2}.

### Evaluation Test of Film Member

Next, plural kinds of film members (film laminated body) in which the film materials forming the film members and the resin material of the junction layer are different were prepared as samples and tests for evaluating solvent resistance and gas barrier properties were conducted using these samples.

TABLE 1

| | Outside film layer | | Gas | | Junction layer | | | | Inside film layer | | | | |
|---|---|---|---|---|---|---|---|---|---|---|---|---|---|
| Sam- | | Thick- | barrier layer | | | | Thick- | | | Thick- | Evaluation | | |
| ple | | ness | SP | | | | ness | SP | | ness | SP | Solvent | Barrier |
| No. | Material | (μm) | value | Material | Method | Adhesive | (μm) | value | Material | (μm) | value | resistance | Properties |
| 1 | PET | 12 | 21.8 | SiO₂ | Deposition | Urethane-based | 3 | 13 | CPP | 25 | 17 | C | B |
| 2 | PET | 12 | 21.8 | SiO₂ | Deposition | Special urethane- | 3 | 20.5 | CPP | 25 | 17 | A | B |
| | | | | | | based | | | | | | | |
| 3 | OPP | 20 | 17 | — | — | Extrusion lamination | — | — | CPP | 25 | 17 | A | C |
| 4 | PET | 12 | 21.8 | — | — | Urethane-based | 3 | 16.5 | CPP | 25 | 17 | C | C |
| 5 | PA | 15 | 21.5 | — | — | Urethane-based | 3 | 16.5 | PE | 20 | 16.4 | B | C |
| 6 | PET | 12 | 21.8 | Alumina | Deposition | Special urethane- | 3 | 20.5 | CPP | 25 | 17 | A | B |
| | | | | | | based | | | | | | | |

* SP value unit: (MJ/m³)^{1/2}

Table 1 shows the configurations of film members used as samples and evaluation results. In Table 1, in regard to six kinds of film members used as samples, the material, thickness and SP value of each of the outside film layers, junction layers and inside film layers which form the film members are shown. In addition, in regard to the gas barrier layer, adhesives (in a case of a bonding method) and methods (deposition and the like) are shown. In Table 1, evaluation test results of solvent resistance and barrier properties (gas barrier properties) of the six kinds of film members are shown.

Samples 1, 2 and 4 to 6 are film members in which the layers are laminated by a bonding method using an adhesive. In addition, Samples 1, 2 and 6 are provided with a gas barrier layer 63 arranged on a surface of an outside film layer 64 opposite to an inside film layer 61, and Samples 3 to 5 are provided without the gas barrier layer 63. The gas barrier layer 63 in the embodiment is formed with a deposited layer formed of an inorganic material. The thickness of the deposited layer has a value in a range of, for example, 20 Å to 1 μm.

Samples 1, 3 and 4 are Comparative Examples. As shown in Table 1, Sample 1 has an outside film layer 64 formed of a PET film having a thickness of 12 μm, and an inside film layer 61 formed of a cast polypolypropylene (CPP (non-axially stretched polypropylene)) film having a thickness of 25 μm. The outside film layer 64 and the inside film layer 61 are bonded by a urethane-based adhesive and a junction layer 62 is formed of a urethane resin material and has a thickness of 3 μm. Further, a gas barrier layer 63 is formed of a deposited layer of SiO₂ (silica). Here, the SP value of PET is 21.8 (MJ/m³)^{1/2}, the SP value of CPP is 17 (MJ/m³)^{1/2}, and the SP value of urethane resin which is the resin material of the junction layer 62 is 13 (MJ/m³)^{1/2}.

In Sample 2, materials of an outside film layer 64, a gas barrier layer 63 and an inside film layer 61 are the same as those of Sample 1. That is, the outside film layer 64 is a PET film having a thickness of 12 μm, and the inside film layer 61 is a CPP film having a thickness of 25 μm. In Sample 2, a special urethane-based adhesive is used to bond the outside film layer 64 and the inside film layer 61. Here, the special urethane-based adhesive belongs to an ester-based adhesive. The special urethane-based adhesive may be an ester-based urethane adhesive, or may be a mixture of ester resin with the urethane-based adhesive. The junction layer 62 is formed of a special urethane resin material (ester-based resin material) and has a thickness of 3 μm. While the SP value of the urethane resin material is 13 (MJ/m³)^{1/2}, the SP value of the special urethane resin material is 20.5 (MJ/m³)^{1/2}. In addition, the gas barrier layer 63 is formed of a deposited layer of SiO₂ as Sample 1.

Sample 3 has an outside film layer 64 formed of an oriented polypropylene (OPP (biaxially stretched polypropylene)) film (SP value=17) having a thickness of 20 μm, and an inside film layer 61 formed of a CPP film (SP value=17) having a thickness of 25 μm, and is a film member in which the outside film layer 64 and the inside film layer 61 are joined by an extrusion lamination method. Since the extrusion lamination method is used, a junction layer 62 is not present. In addition, the film member of Sample 3 is provided without a gas barrier layer 63.

Sample 4 has an outside film layer 64 formed of a PET film (SP value=21.8) having a thickness of 12 μm, and an inside film layer 61 formed of a CPP film (SP value=17) having a thickness of 25 μm, and is a film member in which the outside film layer 64 and the inside film layer 61 are bonded by a urethane-based adhesive. A junction layer 62 is formed of a urethane resin material (SP value=16.5) and has a thickness of 3 μm. In addition, Sample 4 is provided without a gas barrier layer 63.

Sample 5 has an outside film layer 64 formed of a PA film (SP value=21.5) having a thickness of 15 μm, and an inside film layer 61 formed of a PE film (SP value=16.4) having a thickness of 20 μm, and is a film member in which the outside film layer 64 and the inside film layer 61 are bonded by a urethane-based adhesive. A junction layer 62 is formed of a urethane resin material (SP value=16.5) and has a thickness of 3 μm. In addition, Sample 5 is provided without a gas barrier layer 63.

Sample 6 has an outside film layer 64 formed of a PET film (SP value=21.8) having a thickness of 12 μm, and an inside film layer 61 formed of a CPP film (SP value=17) having a thickness of 25 μm, and is a film member in which the inside film layer 61 and the outside film layer 64 are bonded by a special urethane-based adhesive. A junction layer 62 is formed of a special urethane resin material (SP value=20.5) and has a thickness of 3 μm. In addition, a gas barrier layer 63 is formed of a deposited layer of alumina (Al₂O₃).

A solvent resistance evaluation test and a gas barrier property evaluation test were conducted on Samples 1 to 6 and solvent resistance and gas barrier properties were evaluated from the tests.

Here, the solvent resistance evaluation test was conducted using the same solvent ink as the ink I used in the printer 10. As the solvent ink, diethyleneglycol diethyl ether (30% by mass with respect to the total mass of ink), which is a water soluble organic solvent most largely contained in the ink together with a pigment, was used. Here, the SP value of diethyleneglycol diethyl ether is 16.8 (MJ/m³)^{1/2}.

The film members were arranged in a state in which the surface of the film member on the side of the inside film layer 61 was in contact with the solvent ink, and the solvent ink was pressurized with a predetermined pressure (ink pressure) to pressurize the film member from the surface on the side of the inside film layer 61 with the solvent ink having the predetermined pressure. Here, the predetermined pressure (ink pressure) was set to a predetermined pressure higher than the maximum pressure of the pressure chamber 45 during normal use of the valve unit 23 to conduct an acceleration test. After the test was started, the thickness of the film members of Samples was measured and the state of the surfaces of the film members was observed by a magnifying glass at the time point when a predetermined period (a predetermined number of days) elapsed. Presence of swelling of the film members was examined by the measured thickness and the observation. The measurement and the observation were continued until swelling of the film member occurred or for a set period (for example, 120 days) which was sufficient to confirm that swelling of the film member did not occur during normal use of the printer 10.

In addition, the gas barrier property evaluation test was conducted by a differential pressure method in which the inside film layer 61 (low pressure side) separated by the film member was maintained in a vacuum, a test gas (air in the example) was introduced to the outside film layer 64, and the pressure of the low pressure side was increased to measure gas permeability.

The evaluation results are as in Table 1. That is, in the solvent resistance evaluation, the film members of Samples 2, 3 and 6 had a very good (A) solvent resistance, and the film member of Sample 5 had a good (B) solvent resistance. However, the film members of Samples 1 and 4 had a poor solvent resistance.

All Samples 2, 5 and 6 having a good solvent resistance or higher (A and B) satisfied the condition in which the SP value of the resin material forming the junction layer 62 was equal to or larger than the SP value of the resin material forming the inside film layer 61, and the SP value of the resin material forming the outside film layer 64 was equal to or larger than the SP value of the resin material forming the inside film layer 61.

Samples 2 and 6 had a very good solvent resistance (A) for the reason that a difference between the SP value of the resin material forming the junction layer 62 and the SP value of the resin material forming the outside film layer 64 was smaller than a difference between the SP value of the resin material forming the junction layer 62 and the SP value of the resin material forming the inside film layer 61. The reason will be described later using Table 2.

On the other hand, in the gas barrier property evaluation, the film members of Samples 1, 2 and 6 having the gas barrier layer 63 had good gas barrier properties (B). However, Samples 3 to 5 not having the gas barrier layer 63 had poor gas barrier properties. From the results, in order to secure a predetermined level of gas barrier properties, the gas barrier layer 63 is necessary. The result was that the presence of the gas barrier layer 63 had little to do with solvent resistance.

Here, a penetration rate (ease of penetration) when a water soluble organic solvent (diethyleneglycol diethyl ether in the example), which is a main component of a solvent in ink, penetrates the inner surface of the inside film layer 61 in contact with the ink increases as the SP value of the water soluble organic solvent becomes closer to the SP value of the synthetic resin material forming each layer of the film member. Further, the penetration rate decreases when there is a relatively large difference between the SP values thereof.

In the film member, the junction layer 62 and the outside film layer 64 to be joined through the very thin gas barrier layer 63 are directly joined by an adhesive passing through a microscopic gap present on a deposited layer that is microscopically uneven. Therefore, the solvent sequentially penetrates the inside film layer 61, the junction layer 62 and the outside film layer 64. Further, while the solvent penetrates adjacent layers among the inside film layer 61, the junction layer 62 and the outside film layer 64, the penetration rate of the solvent tends to increase as a difference between the SP values of the resin materials forming the layers decreases.

Here, when a difference between the SP values of each resin material of the junction layer 62 and the outside film layer 64 is larger than a difference between the SP values of each resin material of the inside film layer 61 and the junction layer 62, the rate of the solvent penetrating the junction layer 62 and the outside film layer 64 is slower than the rate of the solvent penetrating the inside film layer 61 and the junction layer 62. In this case, due to a difference in the solvent penetration rate, the solvent is easily accumulated at the interface between the junction layer 62 and the outside film layer 64. The adhesive force is relatively weak at the interface, which is a factor of causing interface peeling. Particularly, when the gas barrier layer 63 is provided, the actual adhesion area between the junction layer 62 and the outside film layer 64 is decreased, and the adhesive force of both layers 62 and 64 per unit area becomes relatively weak. Therefore, when the solvent is easily accumulated at the interface between the junction layer 62 and the outside film layer 64, swelling due to interface peeling of both layers 62 and 64 also easily occurs.

Contrarily, when the difference between the SP values of each resin material of the junction layer 62 and the outside film layer 64 is smaller than a difference between the SP values of each resin material of the inside film layer 61 and the junction layer 62, the rate of the solvent penetrating the junction layer 62 and the outside film layer 64 is faster than the rate of the solvent penetrating the inside film layer 61 and the junction layer 62. In this case, due to a difference in the solvent penetration rate, the solvent is not easily accumulated at the interface between the junction layer 62 and the outside film layer 64. As the difference between the SP values of each resin material of the junction layer 62 and the outside film layer 64 becomes smaller, compatibility between the layers is increased and thus, the adhesive force between the junction layer 62 and the outside film layer 64 becomes stronger. Particularly, when the gas barrier layer 63 which hinders adhesion of junction layer 62 and the outside film layer 64 is provided, the adhesive force of both layers 62 and 64 per unit contact area becomes relatively strong. Therefore, even when the solvent is accumulated at the interface between both layers 62 and 64, interface peeling (swelling) is prevented from occurring.

To analyze a factor in determination of whether solvent resistance was good or poor, the difference between the SP values of the inside film layer 61 and the junction layer 62 was set to ΔSP1 and the difference between the SP values of the junction layer 62 and the outside film layer 64 was set to ΔSP2, and the values were compared with each other. The differences ΔSP1 and ΔSP2, and the magnitude relationship thereof are collected based on each data of the tests results in Table 1, and the result is shown in Table 2.

TABLE 2

| | Difference | | Difference | |
|---|---|---|---|---|
| | between SP | | between SP | |
| | values of | | values of | |
| | outside | Magnitude | junction | |
| | film layer | relationship | layer | |
| | and junction | between | and inside | Evaluation |
| Sample | layer | ΔSP1 | film layer | Solvent |
| No. | ΔSP2 | and ΔSP2 | ΔSP1 | resistance |
| 1 | 8.8 | > | 4 | C |
| 2 | 1.3 | < | 3.5 | A |
| 3 | — | — | — | A |
| 4 | 5.3 | > | 0.05 | C |
| 5 | 5 | > | 0.01 | B |
| 6 | 1.3 | < | 3.5 | A |

* SP value unit: (MJ/m³)^{1/2}

In Table 2, the difference ΔSP1 represents the absolute value of the difference between the SP value of the resin material forming the inside film layer 61 and the SP value of the resin material forming the junction layer 62. In the same manner, the difference ΔSP2 represents the absolute value of the difference between the SP value of the resin material forming the junction layer 62 and the SP value of the resin material forming the inside film layer 61.

As shown in Table 2, when ΔSP2 is equal to or smaller than ΔSP1, that is, the difference ΔSP2 between the SP values of the junction layer and the outside film layer is smaller than the difference ΔSP1 between the SP values of the inside film layer and the junction layer (ΔSP2<ΔSP1), solvent resistance is good.

The SP value of diethyleneglycol diethyl ether which is most largely contained in the solvent ink of the embodiment as a water soluble organic solvent is 16.8 ((MJ/m³)^{1/2}). The SP value of the water soluble organic solvent which is most largely contained has substantially the same value as the SP values of CPP (SP=17) and PE (SP=16.4) used as the resin material of the inside film layer, and the water soluble organic solvent easily penetrates the inside film layer 61. In this case, it is preferable that the water soluble organic solvent which has penetrated the inside film layer 61 be promptly discharged to the outside. However, as long as an SP value condition of ΔSP2<ΔSP1 is satisfied, the penetrated water soluble organic solvent can be promptly discharged.

As shown in Table 2, it is apparent that a very good solvent resistance (A in the solvent resistance evaluation) can be obtained according to film members (Samples 2, 3 and 6) manufactured by laminating films in which a resin material satisfying the SP value condition of ΔSP2<ΔSP1 are selected.

Next, actions of the printer 10 and the film member will be described.

In the printer 10, the film members 38, 40, 42 and 44 are used in portions of the pressure chamber 45, the ink supply chamber 43, the damper 34 and the flow passage sections 33a and 35a of the valve unit 23, which are in contact with the solvent ink I. In the film members 38, 40, 42 and 44, the SP value of the resin material forming the junction layer 62 is equal to or larger than the SP value of the resin material forming the inside film layer 61, and the SP value of the resin material forming the outside film layer 64 is equal to or larger than the SP value of the resin material forming the inside film layer 61. Further, the difference ΔSP2 between the SP value of the resin material forming the junction layer 62 and the SP value of the resin material forming the outside film layer 64 is smaller than the difference ΔSP1 between the SP value of the resin material forming the junction layer 62 and the SP value of the resin material forming the inside film layer 61 (ΔSP2<ΔSP1).

Accordingly, the solvent in the solvent ink I, which has penetrated the surfaces of film members 38, 40, 42 and 44 on the inside film layer 61, promptly penetrates each of layers 61, 62 and 64 without accumulation of the solvent at the interface and is discharged to the outside. As a result, swelling (interface peeling) in the film members 38, 40, 42 and 44 caused by accumulation of the penetrated water soluble organic solvent at the interface can be prevented. For example, since swelling of the film member 44 does not occur, ink pressure fluctuation caused by a shift of opening or closing timing of the valve unit 23 due to the swelling can be efficiently prevented. Additionally, since swelling of the film members 38, 40 and 42 is prevented, the flow passage sections 33a and 35a, the damper 34 and the ink supply chamber 43 normally function. Further, since a lifespan of the film members 38, 40, 42 and 44 can be secured, the flow passage sections 33a and 35a, the damper 34, the ink supply chamber 43 and the pressure chamber 45 normally function for a long period of time.

According to the above embodiments, the following effects can be obtained.

(1) The film member was formed of a resin material satisfying the condition in which the SP value of the resin material forming the junction layer 62 was equal to or larger than the SP value of the resin material forming the inside film layer 61, and the SP value of the resin material forming the outside film layer 64 was equal to or larger than the SP value of the resin material forming the inside film layer 61. Therefore, a water soluble organic solvent penetrating the inside film layer 61 in contact with ink penetrates the junction layer 62 and the outside film layer 64 without a great difference in the penetration rate. That is, the penetration rate into the junction layer 62 on the upstream side in a penetration direction is not remarkably faster than the penetration rate into the outside film layer 64 on the downstream side in the penetration direction. Accordingly, it is possible to prevent swelling (interface peeling) in the film member caused by accumulation of the water soluble organic solvent at the interface between the layers of the film member in the middle of penetration of the solvent. For example, since swelling of the film member 44 does not occur, it is possible to avoid accuracy deterioration in opening and closing timing of the valve unit 23 caused by this type of swelling. As a result, fluctuation in ink supply pressure to the recording head 17, fluctuation in ink ejecting timing of the recording head 17 caused by the fluctuation, and fluctuation in the landing position of ink droplets caused by the fluctuation can be avoided or reduced.

(2) In the film member, the difference ΔSP2 between the SP value of the resin material forming the junction layer 62 and the SP value of the resin material forming the outside film layer 64 was set to be smaller than the difference ΔSP1 between the SP value of the resin material forming the junction layer 62 and the SP value of the resin material forming the inside film layer 61. Thus, the rate of the solvent of the ink penetrating between the junction layer 62 and the outside film layer 64 which have a smaller difference between the SP values is faster than the rate of the solvent of the ink penetrating between the inside film layer 61 and the junction layer 62. Further, the adhesive force (per unit contact area) between the junction layer 62 and the outside film layer 64 which have a smaller difference between the SP values is stronger that the adhesive force (per unit contact area) between the inside film layer 61 and the junction layer 62 at the interface. Therefore, even when the solvent penetrates the film member 44, the interface between the layers 62 and 64 is not easily peeled and therefore, swelling of the film members 38, 40, 42 and 44 can be efficiently prevented.

(3) Since the gas barrier layer 63 is provided between the junction layer 62 and the outside film layer 64, gas (air) does not easily penetrate the film member. Accordingly, the gas penetrating the film member from the atmosphere side can be prevented from being mixed with the ink I. In addition, when the gas barrier layer 63 is interposed between the junction layer 62 and the outside film layer 64, the adhesive force (per unit contact area) between the junction layer 62 and the outside film layer 64 with interposing of the microscopic gap of the gas barrier layer 63 formed of a deposited layer is increased. Therefore, peeling between the layers does not easily occur and swelling of the film member can be prevented from occurring.

(4) As the resin material of the inside film layer 61 forming the film member, polypropylene (SP value=17) or polyethylene (SP value=16.4) was used. Therefore, swelling of the film member can be prevented and precipitation of foreign materials in the ink from the film member can be reduced.

(5) As the resin material of the outside film layer 64 forming the film member, polyester or polyamide (SP value=27.8) was used. Therefore, swelling of the film member can be prevented and fixation of the film member and the heating tool can be prevented during thermal welding.

(6) The SP value of a water soluble organic solvent which is most largely contained among water soluble organic solvents contained in the solvent ink (liquid) was equal to or larger than 16.5 and smaller than 24.6. Therefore, since the difference between the SP values of PET and PP used as the resin materials of each film layer forming the film member, and the SP value of the solvent can be reduced, swelling caused by penetration of the solvent into the film member can be prevented.

(7) The water soluble organic solvent which was most largely contained in the solvent ink was diethyleneglycol diethyl ether (SP value=16.8 ((MJ/m³)^{1/2}), and the content thereof was equal to or more than 30% by mass with respect to the total mass of ink. That is, the water soluble organic solvent having an SP value of equal to or larger than 16.5 and smaller than 24.6 is contained in the ink at a content of equal to or more than 30% by mass with respect to the total mass of ink. Therefore, it is possible to prevent swelling of the film member caused by variation in the penetration rate of the solvent ink penetrating the film member between the layers.

(8) In the printer 10, the film member was used in a portion which is in contact with the solvent ink (liquid). Therefore, even when the solvent ink is used, it is possible to prevent swelling of the film member which forms at least a part of the ink flow passages such as the flow passage sections 33a and 35a, the ink supply chamber 43, the pressure chamber 45 and the damper 34 in the valve unit 23, and the ink pack 19P.

The invention is not limited to the above embodiments and can be also implemented in the following embodiments.
As long as the condition in which the SP value of the resin material forming the junction layer is equal to or larger than the SP value of the resin material forming the inside film layer, and the SP value of the resin material forming the outside film layer is equal to or larger than the SP value of the resin material forming the inside film layer is satisfied, the resin materials forming each layer may be appropriately changed. The resin material forming the inside film layer is not limited to polypropylene or polyethylene. In addition, the resin material forming the outside film layer is not limited to polyester or polyamide.
Further, as long as the condition in which a difference between the SP value of the resin material forming the junction layer and the SP value of the resin material forming the outside film layer is smaller than a difference between the SP value of the resin material forming the junction layer and the SP value of the resin material forming the inside film layer is satisfied, the resin materials forming each layer may be appropriately changed.
When a dry lamination method is used, a urethane resin adhesive which satisfies the SP value condition described in the above embodiment may be used as an adhesive forming the junction layer 62, and more preferably, a polyester-based polyurethane adhesive may be used. Among them, preferable is a two-component polyester-based polyurethane adhesive which is disclosed in JP-A-5-179222 and in which a styrene-maleic anhydride copolymer having improved heat-resistant adhesive properties, heat-resistant aqueous adhesive properties and oil-proof adhesive properties is blended.
Considering gas barrier properties, a gas barrier layer 63 formed of a film layer (including a coating layer) may be provided between the outside film layer 64 and the junction layer 62 instead of a deposited layer. In this case, as a resin material for this type of gas barrier layer 63, polyvinylidene chloride (PVDC) and an ethylene-vinyl alcohol copolymer resin (EVOH) of which SP values are close to the SP value of PET are preferable.
Considering gas barrier properties, a deposited layer (SiO₂ or alumina) has been provided between the outside film layer and the junction layer. However, as long as necessary gas barrier properties are secured, the deposited layer may be not provided.
The composition of ink can be appropriately changed. For example, the ink contains a pigment, a polymer dispersant, water and water soluble organic solvents, and a content of water is equal to or more than 10% by mass and less than 50% by mass with respect to the total mass of ink. An SP value of a water soluble organic solvent which is most largely contained among the water soluble organic solvents is equal to or larger than 16.5 and smaller than 24.6, and further, the water soluble organic solvent having an SP value of equal to or larger than 16.5 and smaller than 24.6 and a content of equal to or more than 30% by mass and less than 90% by mass with respect to the total mass of ink can be used. In addition, a solvent-based ink having a composition disclosed in JP-A-2007-246866 (for example, paragraphs [0014], [0015], [0029] to [0055] and the like) can be also used.
As the resin material of the inside film layer, polypropylenes other than CPP such as OPP (biaxially stretched polypropylene) or the like can be used.
The valve unit is not limited to the pressure regulating valve and the film member may be provided in a valve having another function. For example, the film member may be used in a diaphragm of which outer surface is arranged toward the atmosphere among valves such as a flow regulating valve and a choke valve.
A portion or a unit formed by using the film member in a portion in contact with liquid is not limited to the component of the valve unit. For example, at least one of the valve unit (liquid chamber such as the liquid supply chamber or the pressure chamber), the liquid flow passage and the damper is provided in the liquid ejecting head, the carriage, the cartridge holder or the ink cartridge in the liquid ejecting apparatus and can be formed using the film member.
A portion or a unit formed by using the film member in a portion in contact with liquid may be at least one of the liquid flow passage (for example, flow passage sections 33a and 35a), the damper 34, the liquid supply chamber (for example, ink supply chamber 43), the pressure chamber 45 and the ink pack 19P. In addition, a valve unit (valve) having a filter member in a portion in contact with liquid may be provided, for example, in the liquid ejecting head, the carriage main body, the cartridge holder or the ink cartridge in the liquid ejecting apparatus. Further, at least one of the liquid flow passage and the damper is not limited to the component of the valve unit, and one of the liquid flow passage and the damper can be formed using the film member, for example, in the liquid ejecting head, the carriage, the cartridge holder or the ink cartridge in the liquid ejecting apparatus. In addition, when the plural film members are used in the portion or the unit, the materials (resin materials) of the plural layers forming the film members may be different from each other, provided that the SP value described in the above embodiment is satisfied.
The ink flow passage (liquid flow passage) formed using the film member is not limited to the ink supply flow passage and for example, may be an ink discharge flow passage for discharging an ink to be wasted (waste ink) to a ink tank.
The liquid is not limited to the solvent ink. As an example of the liquid, a non-solvent-based ink (for example, aqueous ink) may be used.
The liquid ejecting apparatus is not limited to the serial printer and the invention may be applied to a line printer and a page printer.
The medium used in the liquid ejecting apparatus is not limited to paper and a resin film, a resin sheet, a metal sheet, a fabric, a clothing and the like may be used. In addition, the medium is not limited to a planar shape and may be a stereoscopic object.
The liquid ejecting apparatus is not limited to the ink jet type printer 10 in the above embodiment and may be a liquid ejecting apparatus which ejects or discharges liquid other than ink. The liquid ejecting apparatus discharges a very small amount of liquid droplets. In this case, a state of liquid includes liquid droplets leaving a tail in a granular shape, a tear-like shape, and a thread-like shape. In addition, the “liquid” referred hereinbefore may be any material which can be ejected by the liquid ejecting apparatus. For example, a material in a liquid state may be used. In addition, a liquid state having a high or low viscosity, a sol, a gel water, other fluid states such as inorganic solvents, organic solvents, solutions, liquid resins, and liquid metals (metal solution) may be included.
In addition, a material where particles of a functional material formed of a solid material such as pigments or metal particles are dissolved into a solvent, dispersed, or mixed as well as a liquid as a one-state material may be included. As a representative example of the liquid, there may be an ink described in the above embodiments or a liquid crystal. Herein, the ink may include general water-based ink and oil-based ink and various liquid compounds such as a gel ink and a hot-melt ink.
Specific examples of liquid ejecting apparatuses include liquid ejecting apparatuses for ejecting liquids that contain materials such as electrode materials or coloring matter in dispersed or dissolved form, used for manufacturing, for example, liquid crystal displays, EL (electroluminescence) displays, surface emitting displays, color filters, and the like. In addition, liquid ejecting apparatuses for ejecting bioorganic compounds for use in biochip manufacturing, liquid ejecting apparatuses for ejecting specimen liquids and for use as precision pipettes, textile printing devices, microdispensers, and the like may be adopted. Further, liquid ejecting apparatuses for pinpoint ejection of lubricants into precision instruments such as clocks or cameras, and liquid ejecting apparatuses adapted to eject solutions of transparent resins such as ultraviolet-curing resins and the like onto substrates for the purpose of forming very small semi-spherical lenses (optical lenses) for use in optical communication elements or the like may be adopted. Further, liquid ejecting apparatuses for ejecting etchant solutions such as acid and alkali for etching substrates and the like may be adopted.

### CROSS REFERENCES TO RELATED APPLICATIONS

The entire disclosure of Japanese Patent Application No. 2012-286264, filed Dec. 27, 2012 is expressly incorporated by reference herein.

What is claimed is:

1. A film member which is used in a portion in contact with liquid in a liquid ejecting apparatus, comprising:
an inside film layer which is disposed on a surface in contact with the liquid;
an outside film layer which is disposed on the opposite side to the surface of the inside film layer in contact with the liquid; and
a junction layer which is disposed between the inside film layer and the outside film layer to join the inside film layer and the outside film layer,
wherein an SP value (here, the SP value represents a solubility parameter value) of a resin material which forms the junction layer is equal to or larger than an SP value of a resin material that forms the inside film layer, and an SP value of a resin material that forms the outside film layer is equal to or larger than the SP value of the resin material that forms the inside film layer.

2. The film member according to claim 1,
wherein the resin material of the inside film layer is polypropylene or polyethylene.

3. The film member according to claim 1,
wherein the resin material of the outside film layer is polyester or polyamide.

4. The film member according to claim 1,
wherein a difference between the SP value of the resin material that forms the junction layer and the SP value of the resin material that forms the outside film layer is smaller than a difference between the SP value of the resin material that forms the junction layer and the SP value of the resin material that forms the inside film layer.

5. A liquid ejecting apparatus comprising the film member according to claim 1 in the portion which is in contact with the liquid.

6. A liquid ejecting apparatus comprising the film member according to claim 2 in the portion which is in contact with the liquid.

7. A liquid ejecting apparatus comprising the film member according to claim 3 in the portion which is in contact with the liquid.

8. A liquid ejecting apparatus comprising the film member according to claim 4 in the portion which is in contact with the liquid.

9. The liquid ejecting apparatus according to claim 5,
wherein an SP value of a water soluble organic solvent which is most largely contained among water soluble organic solvents contained in the liquid is equal to or larger than 16.5 and smaller than 24.6.

10. The liquid ejecting apparatus according to claim 9,
wherein the water soluble organic solvent which is most largely contained in the liquid is diethyleneglycol diethyl ether, and a content thereof is equal to or more than 30% by mass with respect to total mass of ink.
